(19) United States
(12) Patent Application Publication
(10) Pub. No.: US 2007/0114157 A1
(43) Pub. Date: May 24, 2007

(54) Screening apparatus for screening pulp suspensions and method of operating the apparatus

(75) Inventor: Börje Fredriksson, Grastorp (SE)

Correspondence Address: LERNER, DAVID, LITTENBERG,;KRUMHOLZ & MENTLIK, 600 SOUTH AVENUE WEST, WESTFIELD, NJ, 07090, US

(73) Assignee: Metso Paper, Inc., Helsinki (FI)

(21) Appl. No.: 10/581,146

(22) PCT Filed: Dec. 3, 2004
(86) PCT No.: PCT/SE04/01799

§ 371 Date: May 31, 2006

(30) Foreign Application Priority Data
Dec. 4, 2003 (SE) 0303260-4

(51) Int. Cl. B07B 1/20

(52) U.S. Cl. 209/305

(57) ABSTRACT

A screening apparatus for screening pulp suspensions is disclosed, comprising a housing, a screen basket having a tubular mantle wall with screen apertures, the mantle wall dividing the interior of the housing into a central chamber and an outer substantially annular chamber, and a rotor arranged in the housing for providing pressure and suction pulses in the suspension to be screened along the mantle wall. At least one elongated support element connects the screen basket to the housing and at least one load sensor is arranged on the support element for sensing the load exerted by the screen basket on the support element during operation of the apparatus. A control unit controls at least one operating parameter, such as the consistency of the suspension or rotational speed of the rotor, during operation in response to signals from the load sensor.

### FIELD OF THE INVENTION

The present invention relates to a screening apparatus for screening fiber pulp suspensions, comprising a housing, a screen basket having a tubular mantle wall with screen apertures, the mantle wall dividing the interior of the housing into a central chamber and an outer substantially annular chamber, an inlet member for supplying a suspension to be screened into either the central chamber or the outer chamber, an accept outlet member for discharging a developed accept fraction of the suspension that has passed through the screen apertures, and a reject outlet member for discharging a developed reject fraction of the suspension. The apparatus according to the present invention further comprises a rotor arranged in the housing for providing pressure and suction pulses in the suspension to be screened along the mantle wall. The present invention also relates to a method of operating such an apparatus.

### BACKGROUND OF THE INVENTION

In the pulp and paper making industry, the above-reference type of pressure screening apparatus is used for cleaning fiber pulp suspensions from undesired solid particles, such as debris, wood chips, and the like. Normally such a pressure screening apparatus is connected to a system of other screening apparatuses, so that the suspension is treated in several cleaning stages. The performance of each individual cleaning stage is dependent on the performance of other stages. Therefore, it is very important that each pressure screening apparatus is monitored and controlled for optimum screening efficiency to secure a high cleanliness of the final cleaned pulp suspension.

It is known to monitor the operation of pressure screening apparatuses of the above-described type by recording data related to the flow of suspension fed to the apparatus, the accept fraction flow, reject fraction flow leaving the apparatus, motor load or differential pressure between the feed and accept fraction flows. For example, U.S. Pat. No. 6,324,490 B1 discloses a system for monitoring the performance of a pressure filter screen, in order to determine when a screen plate of the screen basket should be changed due to plate wear. The known system employs one or more sensors that may sense the feed flow, accept flow, reject flow, dilution water flow, pressure drop across the filter screen, or pressure of the feed flow, accept flow, reject flow or dilution water flow. Other sensors may be employed to sense consistency or viscosity of the suspension downstream of the filter screen. Sensed data from at least the most recent four-hour period of operation are analysed to determine whether the filter screen is performing unacceptably such that one or more of its screen plates should be replaced.

However, such recorded data cannot indicate the momentary operational condition of the screening apparatus. Besides, the limited information that can be derived from such data is not sufficient to detect occasional disturbances in the operation of the screening apparatus. Thus, if the screen basket is exposed to an uneven load, e.g. one foil of the rotor is pulling a higher or lower load than the other foils, this condition cannot be discovered from the recorded data. For example, if the fiber pulp suspension contains long and flexible debris particles they might staple over and drape the leading edge of one or more of the foils. In consequence, the draped foil will lose its suction action on the pulp as it is sweeping along the mantle wall, so that the screen basket is exposed to uneven loads. Furthermore, the draping particles might mechanically transfer energy to the screen basket and cause uneven load and a premature failure of the screen basket. Such abnormal conditions can exist for some time in the screening apparatus without being detected.

Another abnormal condition might arise because of an occasionally uneven load exerted on the mantle wall of the screen basket by the rotor due to oversized particles being caught between the rotor foils and the mantle wall. Normally such situations are of short duration but if frequent they significantly shorten the lifetime of the screen basket. Such oversized particles can be chips in a thermomechanical pulp (TMP) line or debris in a line for production of recycled fibre pulp.

Thus, if a foil is disabled to perform its intended function due to draping of the leading end of the foil or due to particles being caught between the foil and the mantle wall of the screen basket, there is no way for the operator to learn about this undesired condition until it is too late. A great number of screen basket failures in the past can be attributed to such abnormal conditions, which have passed unnoticed by the operators.

One of the objects of the present invention is to provide a screening apparatus of the type described above, the operation of which is controlled to maintain the desired quality of the screened suspension leaving the apparatus. Another object of the present invention is to provide a screening apparatus, the operation of which is controlled to protect the apparatus in time if an abnormal operation condition occurs.

### SUMMARY OF THE INVENTION

In accordance with the present invention, these and other objects can now be realized by a screening apparatus of the type discussed above initially characterised by at least one elongated support element connecting the screen basket to the housing, at least one load sensor arranged on the support element for sensing the load exerted by the screen basket on the support element during operation of the apparatus, and a control unit that controls at least one operating parameter during operation in response to signals from the load sensor.

In accordance with one embodiment of the present invention, the operation of the screening apparatus can immediately be automatically adjusted if the sensed load on the support element deviates from a normal value. The operating parameter may be the consistency of the pulp suspension fed to the apparatus, the flow of the accept fraction, the flow of the reject fraction, the supply of dilution liquid to the reject fraction or the rotational speed of the rotor, as will be explained in the following discussion.

In accordance with another embodiment of the present invention, the control unit generally controls the rotational speed of the rotor, as the operating parameter, in response to signals from the load sensor. In case the load on the support element should be abnormal, for example due to oversized particles being caught between the rotor foils and the mantle of the screen basket, the control unit suitably controls the rotor to stop rotating in response to signals from the load sensor indicating such abnormal loads.

In accordance with another embodiment of the present invention, the apparatus may comprise an alarm, wherein the control unit activates the alarm when abnormal loads are indicated. By such an alarm the attention of the operator can be immediately called, whereby the operator can take appropriate precautionary measures in time, such as flushing the screen by fully opening the reject fraction valve a short interval, decreasing the RPM of the rotor or stopping the operation to allow inspection of the screening apparatus. The alarm may comprise a loudspeaker or visual means, e.g. twinkling lamps.

In accordance with another embodiment of the present invention, the support element connects the screen basket and the housing at a first position, and an additional or second support element connects the screen basket and housing at a second position circumferentially displaced from the first position relative to the screen basket. An additional load sensor is arranged on the additional support element for sensing a load exerted by the screen basket on the second support element during operation of the apparatus. In this embodiment, the control unit controls the operating parameter in response to signals from the first-mentioned and additional load sensors. Suitably, the control unit controls the operating parameter in response to the signals simultaneously emitted by the first and second load sensors, i.e. the respective character of the signals at the same point of time. The control unit may control the rotational speed of the rotor, as the operating parameter, in response to signals from the two load sensors. In case the signals from the two load sensors indicate an abnormal difference between the load sensed by the first load sensor and the load sensed by the second load sensor, the control unit suitably controls the rotor to stop rotating. In addition, or in combination, the control unit may activate the above-mentioned alarm in response to signals from the load sensors indicating such an abnormal difference between the two loads.

In accordance with this embodiment of the present invention, the attention of the operator can be immediately called by the alarm when the screen basket is exposed to harmful uneven loads, whereby the operator can take appropriate precautionary measures, such as flushing the screen by fully opening the reject fraction valve a short interval, decreasing the RPM of the rotor or stopping the operation to allow inspection of the screening apparatus.

In accordance with a preferred embodiment of the present invention, the rotor is arranged in the central chamber and the support element extends in the outer chamber. In this embodiment the screening apparatus comprises a dilution liquid header on the mantle wall of the screen basket for supplying dilution liquid, such as water, to the central chamber to counteract thickening of the suspension during operation, at least one dilution liquid supply pipe for supplying dilution liquid from outside the housing to the header and a pump for pumping dilution liquid through the supply pipe to the header. The header divides the screen basket into two screening sections, a primary screening section and a secondary screening section. The header is used for supplying dilution water to a developed primary thickened reject fraction leaving the primary screening section to dilute the primary reject fraction to a proper feed consistency, normally the same feed consistency as that of the incoming suspension. The diluted primary reject fraction then is screened in the secondary screening section. The two accept fractions developed at the primary and secondary screening sections are combined and discharged through the accept fraction outlet member.

The flow of dilution liquid that is necessary to supply to the reject fraction developed in the primary screening section depends on the type of pulp, the production rate and the design and operating variables of this type of screening apparatus. Even small variations in fiber length and dewatering properties affect the thickening propensity of the fiber pulp suspension. In the preferred embodiment, the control unit controls as the operating parameter the flow of dilution liquid pumped by the pump in response to signals from the load sensor, so that the dilution of the thickened primary reject fraction always is appropriate.

The torque transmitted by the rotor through the pulp to the screen basket during operation creates a tangential load on the screen basket. This tangential load is a function of the consistency of the suspension being screened by the screen basket. Increasing consistency, i.e. increasing thickening, increases the force required for shearing and fluidising a layer in the screen basket close to the surface of the mantle wall. Accordingly, the tangential load on the screen basket is a function of the thickening propensity of the fiber pulp suspension, which is dependent on freeness and fiber length, as well as accept fraction flow rate and reject fraction flow rate. The load sensor, for example in the form of a strain gauge, senses the tangential load of the screen basket exerted on the support element. The control unit may control the pump to change the flow of dilution liquid in response to signals from the load sensor indicating a change in the load on the support element, so that the dilution of the primary reject fraction is appropriate. More specifically, the control unit may control the pump to increase the flow of dilution liquid in response to signals from the sensor indicating an increase in the load on the support element and vice versa.

In accordance with one embodiment of the present invention, the sensor may be a piezoelectric sensor, which is particularly suited for sensing rapid changes in the load on the support element due to damaging vibrations of the screen basket exerted on the support element. Such damaging vibrations occur when the rotor foils operate improperly.

In accordance with another embodiment of the present invention, the support element comprises the dilution liquid supply pipe. In this embodiment the sensor suitably is arranged on the dilution liquid supply pipe. Alternatively, the sensor may comprise an annular sensor surrounding the dilution liquid supply pipe and attached to the housing and the supply pipe.

In accordance with a preferred embodiment of the present invention, the apparatus may include two support elements provided with two load sensors, respectively, as described above in connection with the particular embodiment. In this case, the control unit controls the flow of dilution liquid pumped by the pump in response to signals from the two load sensors, preferably to signals simultaneously emitted by the load sensors. The control unit may control the flow of dilution liquid pumped by the pump to change in response to signals from the load sensors indicating changes in the loads on the support elements. For example, to control the flow of dilution liquid to increase in response to signals from the load sensors indicating an increase in the loads on the support elements. The two support elements may comprise two dilution liquid supply pipes, wherein the two load sensors suitably are arranged on the two dilution liquid supply pipes, respectively. Each load sensor may comprise an annular sensor surrounding its associated supply pipe and attached to the housing and the supply pipe.

In accordance with the present invention, a method of operating the screening apparatus is also provided. Thus, the method of the present invention comprises:
providing at least one elongated support element connecting the screen basket to the housing,
supplying a pulp suspension to either the central chamber or the outer chamber so that the suspension is screened into an accept fraction of the suspension that passes through the screen apertures of the mantle wall and a reject fraction of the suspension that does not pass through the screen apertures,
rotating the rotor to provide pressure and suction pulses in the suspension along the mantle wall,
sensing the load exerted by the screen basket on the support element, and
controlling at least one operating parameter of the apparatus in response to the sensed load.

In accordance with one embodiment of the method of the present invention, the operating parameter may comprise the rotational speed of the rotor. For example, the rotor may be controlled to stop rotating in response to sensed abnormal loads.

Where the screening apparatus comprises two support elements with two load sensors, the method comprises controlling the operating parameter in response to, preferably simultaneously, sensed loads on the two support elements. Also in this case the operating parameter may comprise the rotational speed of the rotor. The rotor may be controlled to stop rotating in response to sensed loads on the two support elements indicating an abnormal difference between the load on one of the support elements and the load on the other support element.

In accordance with another embodiment of the method of the present invention, the method may further comprise supplying dilution liquid to the central chamber to counteract thickening of the suspension, and controlling as the operating parameter the flow of dilution liquid to the central chamber. Where the screening apparatus comprises one support element the flow of dilution liquid is controlled to change in response to a sensed change in the load on the support element. For example, the flow of dilution liquid may be controlled to increase in response to a sensed increase in the load on the support element. Where the screening apparatus comprises two support elements with two load sensors the method comprises controlling the flow of dilution liquid in response to, preferably simultaneously, sensed loads on the two support elements. The flow of dilution liquid may be controlled to change in response to sensed changes in the loads on the two support elements, e.g. to increase in response to sensed increases in the loads on the two support elements.

### BRIEF DESCRIPTION OF THE DRAWINGS

The present invention may be more fully appreciated with reference to the following detailed description which, in turn, refers to the accompanying drawing, in which

FIG. 1 is a side, partially cut away, perspective view of a preferred embodiment of the screening apparatus of the present invention,

FIG. 2 is a side, sectional, perspective view of a screen basket for use in the apparatus according to FIG. 1,

FIG. 3 is a side, partial, enlarged detail view of the embodiment shown in FIG. 1,

FIG. 4 is a side, partial, enlarged detail view of a modification of the embodiment shown in FIG. 1,

FIG. 5 is a side, partial, enlarged detail view of another modification of the embodiment shown in FIG. 1, and

FIG. 6 is a side, partially cut away perspective view of another general embodiment of the screening apparatus of the present invention.

### DETAILED DESCRIPTION

Referring to the drawing figures, like reference numerals designate identical or corresponding elements throughout the several figures.

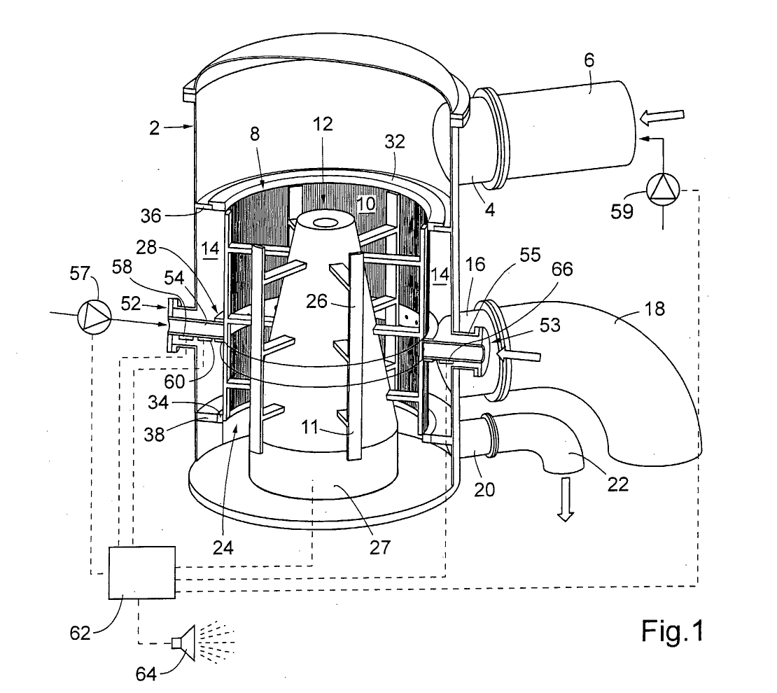

FIG. 1 shows a screening apparatus according to the present invention for screening pulp suspensions, comprising a housing 2, an inlet member 4 releasably connected to a supply pipe 6 for supplying a suspension to be screened into the housing 2, a tubular screen basket 8 dividing the interior of the housing 2 into a central substantially cylindrical chamber 10 for receiving the suspension to be screened at one end 12 of the central chamber 10 and a single outer annular accept chamber 14 for receiving an accept fraction of the suspension that has passed through the screen basket 8, an accept outlet member 16 releasably connected to an accept outlet pipe 18 for discharging the accept fraction from the accept chamber 14 and a reject outlet member 20 releasably connected to a reject outlet pipe 22 for discharging a reject fraction of the suspension from the central chamber 10 at the other end 24 thereof. A rotor 26 driven by a motor 27 is arranged in the central chamber 10 and has six foils 11 for providing pressure and suction pulses in the suspension along the screen basket 8. A dilution liquid annular header 28 is provided for supplying diluting liquid to the central chamber 10 between the ends 12 and 24 thereof.

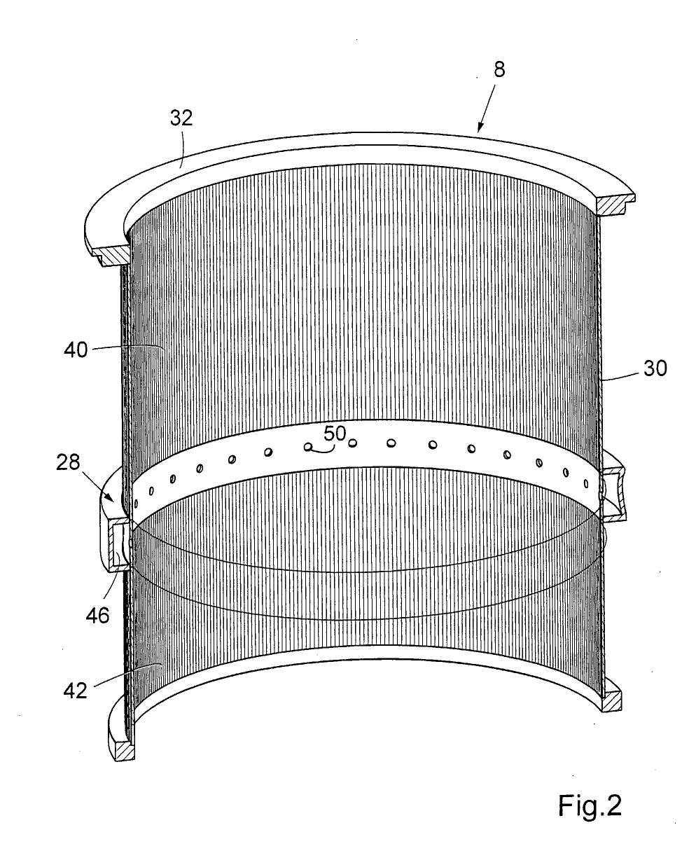

With reference to FIG. 2, the screen basket 8 comprises a cylindrical mantle wall 30 with screen apertures taking the shape of slots. The mantle wall 30 is provided with an upper flange 32 and a lower flange 34 that seal against an upper shoulder 36 on the housing and a lower shoulder 38 on the housing, respectively. The mantle wall 30 is divided into two separate cylindrical parts 40 and 42, which are axially interconnected by the annular header 28. The header 28 forms a tubular dilution liquid channel 46 extending around the mantle wall 30. The header 28 is provided with a multiplicity of ejection nozzles 50 for ejecting dilution liquid from channel 46 to the inside of the screen basket 8.

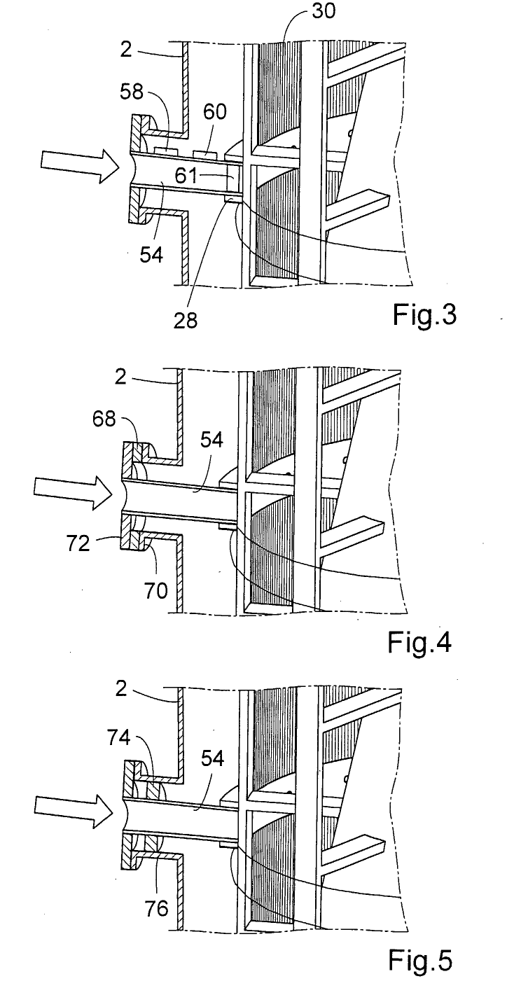

With reference to FIGS. 1 and 3, the support elements, 52,53, include dilution liquid supply pipes 54 and 55, respectively, for supplying dilution liquid to the header 28. The pipes, 54 and 55, are located at opposite sides of the screen basket 8. A load sensor 58, such as a strain gauge, is arranged on the pipe 54 and another load sensor 60, such as a piezoelectric sensor, is also arranged on the pipe 54. Additionally, a pressure sensor 61 is arranged between the supply pipe 54 and the header 28. There is a pump 57 adapted to pump dilution liquid through the pipe 54 to the header 28, see FIG. 1. A consistency adjustment means in the form of a pump 59 is adapted to pump dilution liquid into the supply pipe 6 to mix with and dilute incoming pulp suspension. A control unit 62 is adapted to control the speed of the motor 27 and/or the pump 57 and/or the pump 59 in response to signals from the sensors 58,60, 61. There is an alarm device, here in the form of a loud speaker 64, connected to the control unit 62. The control unit 62 is adapted to control the load speaker 64 to emit an alarm signal in response to any of the sensors, 58,60, and 61, sensing an abnormal operation condition of the screening apparatus.

Another load sensor 66 is arranged on the dilution liquid inlet pipe 66. The control unit 62 is adapted to control the operation of the apparatus in response to signals simultaneously emitted by the load sensors 58 and 66. Thus, if the signals indicate too a great difference or an abnormal difference between the loads simultaneously sensed by the load sensors 58 and 66 the control unit may activate the alarm function or stop the motor 27.

FIG. 4 illustrates a modification of the embodiment shown in FIG. 3. Thus, a load sensor in the form of an annular strain gauge 68 is mounted between a flange 70 on the housing 2 and a flange 72 on the pipe 54. FIG. 5 illustrates another modification of the embodiment shown in FIG. 3. Thus, a load sensor in the form of an annular strain gauge 74 is mounted between the pipe 54 and a pipe socket 76 that surrounds the pipe 54 and is attached to the housing 2.

In operation, a fiber suspension to be screened is fed via the inlet member 4 to the screen basket 8 at the upper end 12 thereof. In the screen basket 8 the suspension is screened along section 40 of the mantle wall 30, so that a primary accept fraction passes through the screen apertures of the mantle wall 30 while a primary reject fraction develops inside the screen basket 8. The primary reject fraction is diluted by a controlled flow of dilution liquid sprayed through the ejection nozzles 50. The diluted primary reject fraction is screened along section 42 of the mantle wall 30, so that a secondary accept fraction passes through the mantle wall 30 while a secondary reject fraction develops inside the screen basket 8 and then is discharged from the screen basket 8 through the reject outlet member 20. The primary and secondary accept fractions are combined and discharged through the accept outlet member 16.

The flow of dilution liquid through the ejection nozzles 50 generally is controlled in response to the consistency and flow of the suspension being fed to the screen basket 8 and the consistency and flow of the secondary reject fraction being discharged from the screen basket 8, so that the consistency of the primary reject fraction entering section 42 of the mantle wall 30 becomes substantially the same as the consistency of the suspension being fed into the screen basket 8. Besides this general control, the control unit 62 controls the pump 57 to change the flow of dilution liquid in response to signals from the load sensor 58 indicating a change in the load on the pipe 54 or to signals from the pressure sensor 61 indicating a change in the pressure exerted by the screen basket on the supply pipe 54. If the sensor 60 senses abnormal loads in the form of vibrations the control unit 62 emits an alarm signal, such as a sound signal from the loud speaker 64 or, alternatively, controls the motor 27 to stop the rotation of the rotor 26. If the load sensor 58 senses an abrupt increase in the load on the pipe 54 indicating an abnormal operation condition the control unit 62 controls the motor 27 to stop the rotation of the rotor 26 and emits an alarm signal.

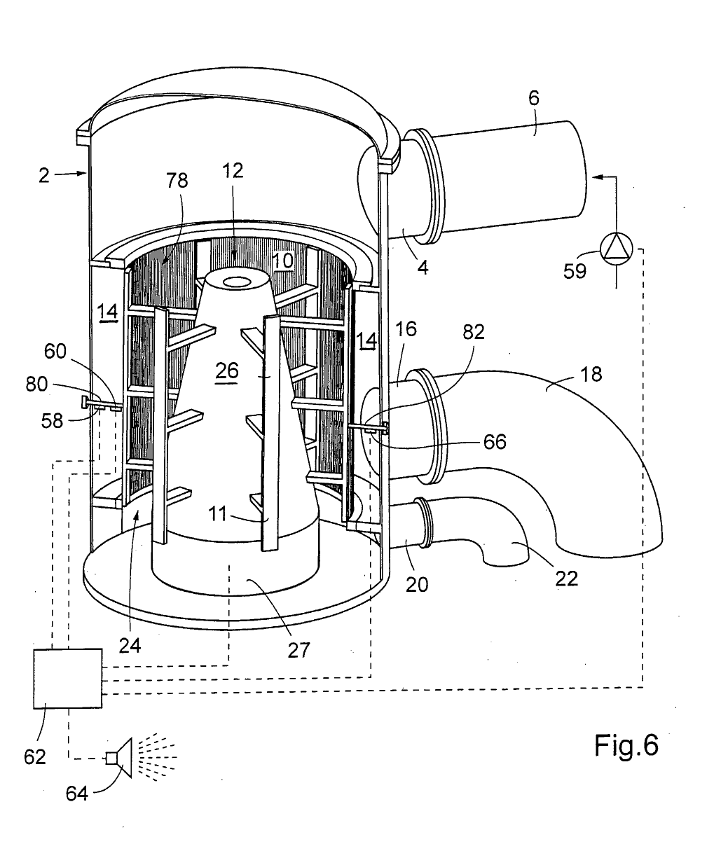

FIG. 6 shows a general embodiment of the invention similar to the embodiment according to FIG. 1 except that there is no dilution liquid supply means and that the screen basket is designed differently. Accordingly, the general embodiment includes an undivided screen basket 78 and two support elements in the form of rods 80 and 82 located at opposite sides of the screen basket 78. The rods, 80 and 82, connect the screen basket 78 to the housing 2. A load sensor 58, such as a strain gauge, is arranged on the rod 80 and another load sensor 60, such as a piezoelectric sensor, is also arranged on the rod 80. In the general embodiment the control unit 62 is adapted to control an operating parameter, typically the speed of the motor 27, in response to signals from the sensors 58,60. The control unit 62 also controls the load speaker 64 to emit an alarm signal in response to any of the sensors 58,60 sensing an abnormal operation condition of the screening apparatus.

Another load sensor 66 is arranged on the other rod 82. The control unit 62 may control the operation of the apparatus in response to signals simultaneously emitted by the load sensors 58 and 66. Thus, if the signals indicate too a great difference or an abnormal difference between the loads simultaneously sensed by the load sensors 58 and 66, the control unit may activate the alarm function or stop the motor 27.

Where applicable, the various elements of the embodiments according to FIGS. 1-5 may also be applied on the general embodiment according to FIG. 6. For example, the annular strain gauge 68 shown in FIG. 4 may be mounted around the rod 80 in the same manner as shown in FIG. 4, and the annular strain gauge 74 shown in FIG. 5 may be mounted around the rod 80 in the same manner as shown in FIG. 5.

Furthermore, the present invention may be implemented in the type of screening apparatuses in which the suspension to be screened is supplied to the outer annular chamber and the rotor is arranged in the central chamber.

Although the invention herein has been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present invention as defined by the appended claims.

1. A screening apparatus for screening pulp suspensions, comprising:
a housing,
a screen basket including a first side and a second side having a tubular mantle wall with screen apertures, the mantle wall dividing the interior of the housing into a central chamber and an outer substantially annular chamber,
an inlet member for supplying a suspension to be screened to one of said first and second sides of said screen basket,
an accept outlet member for discharging a developed accept fraction of the suspension that has passed through the screen apertures,
a reject outlet member for discharging a developed reject fraction of the suspension that has not passed through the screen apertures,
a rotor arranged in the housing for providing pressure and suction pulses in the suspension to be screened along the mantle wall,
at least one elongated support element connecting the screen basket to the housing,
at least one load sensor arranged on the at least one elongated support element for sensing the load exerted by the screen basket on the at least one elongated support element during operation of the apparatus, and
a control unit for controlling at least one operating parameter during operation in response to signals from the load sensor.

2. A screening apparatus according to claim 1, further comprising consistency adjustment means for adjusting the consistency of the suspension to be screened, wherein the at least one operating parameter comprises the consistency of the suspension to be screened controlled by the control unit, whereby the consistency adjustment means adjusts the consistency of the suspension in response to signals from the load sensor.

3. A screening apparatus according to claim 2, wherein the consistency adjustment means comprises a pump for supplying dilution liquid to the suspension to be screened.

4. A screening apparatus according to claim 1, wherein the at least one operating parameter comprises the rotational speed of the rotor, which is controlled in response to signals from the load sensor.

5. A screening apparatus according to claim 4, wherein the control unit controls the rotor to stop rotating in response to signals from the load sensor indicating abnormal loads.

6. A screening apparatus according to claim 1, further comprising an alarm, wherein the control unit activates the alarm in response to signals from the load sensor indicating abnormal loads.

7. A screening apparatus according to claim 1, wherein the at least one elongated support element and the housing comprises a first support element at a first position, and further comprising a second support element connecting the screen basket and housing at a second position circumferentially displaced from the first position relative to the screen basket, and including a second load sensor arranged on the second support element for sensing a load exerted by the screen basket on the second support element during operation of the apparatus, the control unit controlling the operating parameter in response to signals from the first and second load sensors.

8. A screening apparatus according to claim 7, wherein the control unit controls the operating parameter in response to the signals simultaneously emitted by the first and second load sensors.

9. A screening apparatus according to claim 7, further comprising consistency adjustment means for adjusting the consistency of the suspension to be screened, wherein the operating parameter comprises the consistency of the suspension to be screened which is adjusted by the consistency adjustment means in response to signals from the load sensors.

10. A screening apparatus according to claim 9, wherein the consistency adjustment means comprises a pump for supplying dilution liquid to the suspension to be screened.

11. A screening apparatus according to claim 7, wherein the operating parameter comprises the rotational speed of the rotor which is controlled in response to signals from the load sensors.

12. A screening apparatus according to claim 11, wherein the control unit controls the rotor to stop rotating in response to signals from the load sensors indicating an abnormal difference between the load sensed by the first load sensor and the load sensed by the second load sensor.

13. A screening apparatus according to claim 9, further comprising an alarm, wherein the control unit activates the alarm in response to signals from the load sensors indicating an abnormal difference between the load sensed by the first load sensor and the load sensed by the second load sensor.

14. A screening apparatus according to claim 1, wherein the rotor is arranged in the central chamber and the at least one elongated support element extends in the outer chamber.

15. A screening apparatus according to claim 14, further comprising a dilution liquid header on the screen basket for supplying dilution liquid to the central chamber to counteract thickening of the suspension during operation, and a pump for pumping dilution liquid to the header, wherein the operating parameter comprises the flow of dilution liquid pumped by the pump in response to signals from the load sensor.

16. A screening apparatus according to claim 15, wherein the control unit controls the flow of dilution liquid pumped by the pump to change in response to signals from the load sensor indicating a change in the load on the support element.

17. A screening apparatus according to claim 16, wherein the control unit controls the flow of dilution liquid pumped by the pump to increase in response to signals from the load sensor indicating an increase in the load on the at least one elongated support element.

18. A screening apparatus according to claims 15, further comprising at least one dilution liquid supply pipe for supplying dilution liquid from the pump to the header, wherein the at least one elongated support element comprises the dilution liquid supply pipe.

19. A screening apparatus according to claim 18, wherein the load sensor is arranged on the dilution liquid supply pipe.

20. A screening apparatus according to claim 18, wherein the load sensor comprises an annular sensor surrounding the dilution liquid supply pipe and attached to the housing and the supply pipe.

21. A screening apparatus according to claim 15, wherein the at least one elongated support element comprises a first support element at a first position, and further comprising a second support element connecting the screen basket and housing at a second position circumferentially displaced from the first position relative to the screen basket, and a second load sensor arranged on the second support element for sensing a load exerted by the screen basket on the second support element during operation of the apparatus, the control unit controlling the flow of dilution liquid pumped by the pump in response to signals from the load sensors.

22. A screening apparatus according to claim 21, wherein the control unit controls the flow of dilution liquid pumped by the pump in response to signals simultaneously emitted by the load sensors.

23. A screening apparatus according to claim 22, wherein the control unit controls the flow of dilution liquid pumped by the pump to change in response to signals from the load sensors indicating changes in the load on the first and second support elements.

24. A screening apparatus according to claim 23, wherein the control unit controls the flow of dilution liquid pumped by the pump to increase in response to signals from the load sensors indicating an increase in the loads on the support elements.

25. A screening apparatus according to claim 21, further comprising a first dilution liquid supply pipe and a second dilution liquid supply pipe for supplying dilution liquid from the pump to the header, wherein the first support element and the second support element comprise the first dilution liquid supply pipe and second dilution supply pipe, respectively.

26. A screening apparatus according to claim 25, wherein each load sensor is arranged on its associated dilution liquid supply pipe.

27. A screening apparatus according to claim 26, wherein each load sensor comprises an annular sensor surrounding its associated dilution liquid supply pipe and attached to the housing and the supply pipe.

28. A method of operating a screening apparatus including a housing, a screen basket having a first side and a second side and a mantle wall with screen apertures, the mantle wall dividing the interior of the housing into a central chamber and an outer substantially annular chamber, and a rotor arranged in the housing for providing pressure and suction pulses in the suspension to be screened along the mantle wall, the method comprising:
providing at least one elongated support element connecting the screen basket to the housing,
supplying a pulp suspension to one of said first and second sides of said screen basket so that the suspension is screened into an accept fraction of the suspension that passes through the screen apertures of the mantle wall and a reject fraction of the suspension that does not pass through the screen apertures,
rotating the rotor to provide pressure and suction pulses in the suspension along the mantle wall,
sensing the load exerted by the screen basket on the at least one elongated support element, and
controlling at least one operating parameter in response to the sensed load.

29. A method according to claim 28, wherein the operating parameter comprises the consistency of the suspension.

30. A method according to claim 28, wherein the operating parameter comprises a first operating parameter comprises the flow of the accept fraction and including a second operating parameter comprising the flow of the reject fraction.

31. A method according to claim 30, wherein the flow of the accept fraction is controlled to temporarily stop and the flow of the reject fraction is controlled to temporarily increase in response to sensed abnormal loads.

32. A method according to claim 28, wherein the operating parameter comprises the rotational speed of the rotor.

33. A method according to claim 32, wherein the rotor is controlled to stop rotating in response to sensed abnormal loads.

34. A method according to claim 28, wherein said at least one elongated support element comprises a first support element, and including a second support element connecting the screen basket and housing at a position circumferentially displaced relative to the screen basket from the position where the first support element is situated, and sensing the load exerted by the screen basket on the second support element, wherein the operating parameter is controlled in response to sensed loads on the support elements.

35. A method according to claim 34, wherein the operating parameter is controlled in response to simultaneously sensed loads on the support elements.

36. A method according to claim 34, wherein the operating parameter comprises the rotational speed of the rotor.

37. A method according to claim 36, wherein the rotor is controlled to stop rotating in response to sensed loads on the support elements indicating an abnormal difference between the load on the first support element and the load on the second support element.

38. A method according to any one of claims 28, wherein the rotor is arranged in the central chamber, and further comprising supplying dilution liquid to the central chamber to counteract thickening of the suspension, and wherein the operating parameter comprises the flow of dilution liquid to the central chamber.

39. A method according to claim 38, wherein the flow of dilution liquid is controlled to change in response to a sensed change in the load on the support element.

40. A method according to claim 39, wherein the flow of dilution liquid is controlled to increase in response to a sensed increase in the load on the support element.

41. A method according to claim 38, wherein said at least one elongated support element comprises a first support element, and including a second support element connecting the screen basket and housing at a position circumferentially displaced relative to the screen basket from the position where the first support element is situated, and sensing the load exerted by the screen basket on the second support element, wherein the flow of dilution liquid is controlled in response to sensed loads on the support elements.

42. A method according to claim 41, wherein the flow of dilution liquid is controlled in response to simultaneously sensed loads on the support elements.

43. A method according to claim 41, wherein the flow of dilution liquid is controlled to change in response to sensed changes in the loads on the support elements.

44. A method according to claim 43, wherein the flow of dilution liquid is controlled to increase in response to sensed increases in the loads on the first and second support elements.
